(19) United States
(12) Patent Application Publication
(10) Pub. No.: US 2008/0078430 A1
(43) Pub. Date: Apr. 3, 2008

(54) Washing machine

(75) Inventor: Rowland Alexander Errington, New South Wales (AU)

Correspondence Address: LADAS & PARRY, 26 WEST 61ST STREET, NEW YORK, NY, 10023, US

(73) Assignee: TRANSPACIFIC MANUFACTURING SYSTEMS PTY LTD.

(21) Appl. No.: 11/540,917

(22) Filed: Sep. 29, 2006

(51) Int. Cl. B08B 3/00

(52) U.S. Cl. 134/198

(57) ABSTRACT

An automotive parts washing machine (10) having a turntable (20). The turntable (20) has sprocket teeth (26) that are engaged by pins (29) of a pinion assembly (28).

### TECHNICAL FIELD

The present invention relates to washing machines and more particularly but not exclusively to washing machines that clean automotive and industrial components.

### BACKGROUND OF THE INVENTION

It is very common for automotive parts to be hand cleaned. This has the disadvantage of distracting skilled trades people from their normal work, thereby adding to overall costs.

A further disadvantage of manual cleaning is the use of solvents. These can be detrimental as far as the employee's health and the environment are concerned.

The above problems have been addressed by workshops providing specialist automatic washing machines. A problem of these washing machines is their drive systems that are expensive to manufacture and can be unreliable.

### OBJECT OF THE INVENTION

It is the object of the present invention to overcome or substantially ameliorate at least one of the above disadvantages of known means of washing components.

### SUMMARY OF THE INVENTION

There is disclosed herein a washing machine including:

a cabinet to receive items to be washed;

a turntable within the cabinet mounted for rotation about a generally upright turntable axis, the turntable providing a support to receive the items;

a spray assembly including a plurality of nozzles within the cabinet;

a pump to deliver a cleaning liquid under pressure to the spray assembly so that liquid jets, to be directed at the items, issue from the nozzles; and

a drive assembly to rotate the turntable about said axis, said drive assembly including,

a plurality of sprocket teeth, the teeth being part of the turntable and having a major direction of extension generally radially relative to said turntable axis, said teeth being equally angularly spaced about said turntable axis so as to provide a sprocket, and a pinion meshingly engaged with the sprocket and mounted for rotation about a pinion axis, said pinion including a plurality of pinion teeth, the pinion teeth being meshingly engaged with the sprocket teeth having a major direction of extension generally parallel to the turntable axis, and

a motor operatively associated with the pinion to cause rotation thereof about the pinion axis to thereby cause rotation of the turntable about the turntable axis.

Preferably, the turntable is formed of segments that are joined together to form the turntable,

Preferably, each segment extends for approximately 25° about the turntable axis.

Preferably, the pinion teeth are pins that are generally circular in transverse cross section.

Preferably, said turntable includes a central hub, a sprocket base radially spaced from the hub but surrounding the hub and to which said teeth are attached, and a plurality of spokes joining the hub and base so that the base is supported by the hub.

Preferably, said base is a ring extending about the turntable axis, and from which the sprocket teeth radially extend.

Preferably, adjacent sprocket teeth are joined by an arcuate portion.

Preferably, said pinion axis is generally parallel to said turntable axis but spaced laterally therefrom.

### BRIEF DESCRIPTION OF THE DRAWINGS

A preferred form of the present invention will now be described by way of example with reference to the accompanying drawings wherein:

FIG. 1 is a schematic top plan view of a portion of a washing machine to clean industrial and automotive components; and

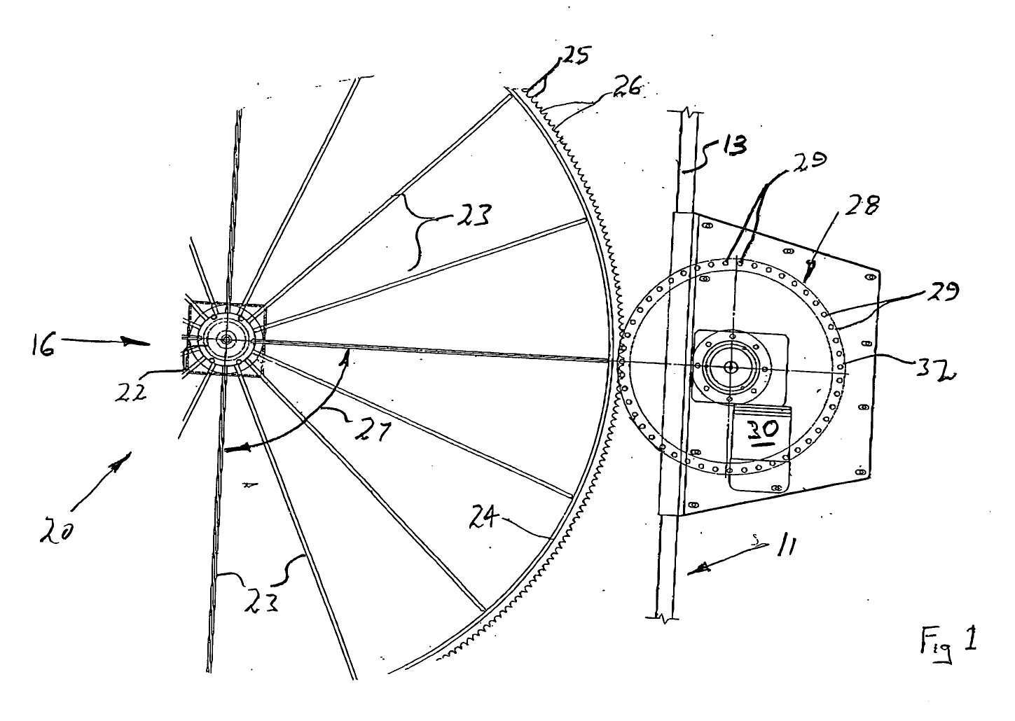

FIG. 2 is a schematic parts sectioned side elevation of the portion of the washing machine of FIG. 1.

### DETAILED DESCRIPTION OF THE PREFERRED EMBODIMENT

In the accompanying drawings there is schematically depicted a washing machine 10. The washing machine 10 includes a cabinet 11 enclosing an interior 12 within which items to be washed are to be located. The cabinet 11 includes a side wall 13 surrounding the interior 12 and to which there is attached a floor 14. Pivotally attached to the side wall 13 is a lid 15 that pivots about a generally horizontal axis between a lowered position, and a raised position. When the lid 15 is in the lowered position, the space 12 is generally enclosed by the cabinet 11. When the lid 15 is in the raised position, a user has access to the interior 12 to place automotive items in there to be cleaned.

Mounted generally centrally and internally of the cabinet 11 is a central hub 16. The hub 16 includes a central stem 17 that would be typically fixed to the floor 14 so as to extend upwardly therefrom so that the stem 17 has a central longitudinal axis 18 that is generally upright (vertically oriented). The stem 17 has bearings and bearing supports 19 that rotatably support a turntable 20 for rotation about the turntable axis 18. The turntable 20 is adapted to receive a tray 21 formed of metal mesh and that would typically receive the items to be cleaned.

The turntable 20 includes a turntable hub 22 that is mounted on the stem 17 for rotation about the axis 18, and from which there radially extends a plurality of spokes 23, The spokes 23 extend radially outward and are fixed to a sprocket base 24 that is essentially a rig surrounding the axis 18. Fixed to the ring 24 and extending radially therefrom are sprocket teeth 25. The sprocket teeth 25 have their major direction of extension generally radially relative to the axis 18. The teeth 25 are equally angularly spaced about the axis 18, with adjacent teeth 25 being joined by arcuate portions 26. Preferably the teeth 25 are located in a single plane that is generally perpendicular to the axis 18. The turntable 20 is generally oriented in a horizontal plane also generally perpendicular to the axis 18.

The turntable 20 is constructed of segments 27, each segment 27 extending about the axis 18 for approximately 25°. Each segment 27 includes a plurality of the sprockets 23 and a segment of the base 24 as well as the teeth 25 fixed thereto. Accordingly in this embodiment there are four segments 27 that are secured together.

Operatively associated with the turntable 20 is a pinion assembly 28. The pinion assembly 28 includes a plurality of pins 29 that engage the teeth 25. The pinion assembly 28 includes a shaft 36 driven by means of a motor 30. The shaft 36 is mounted for rotation and is driven about the generally upright pinion axis 31.

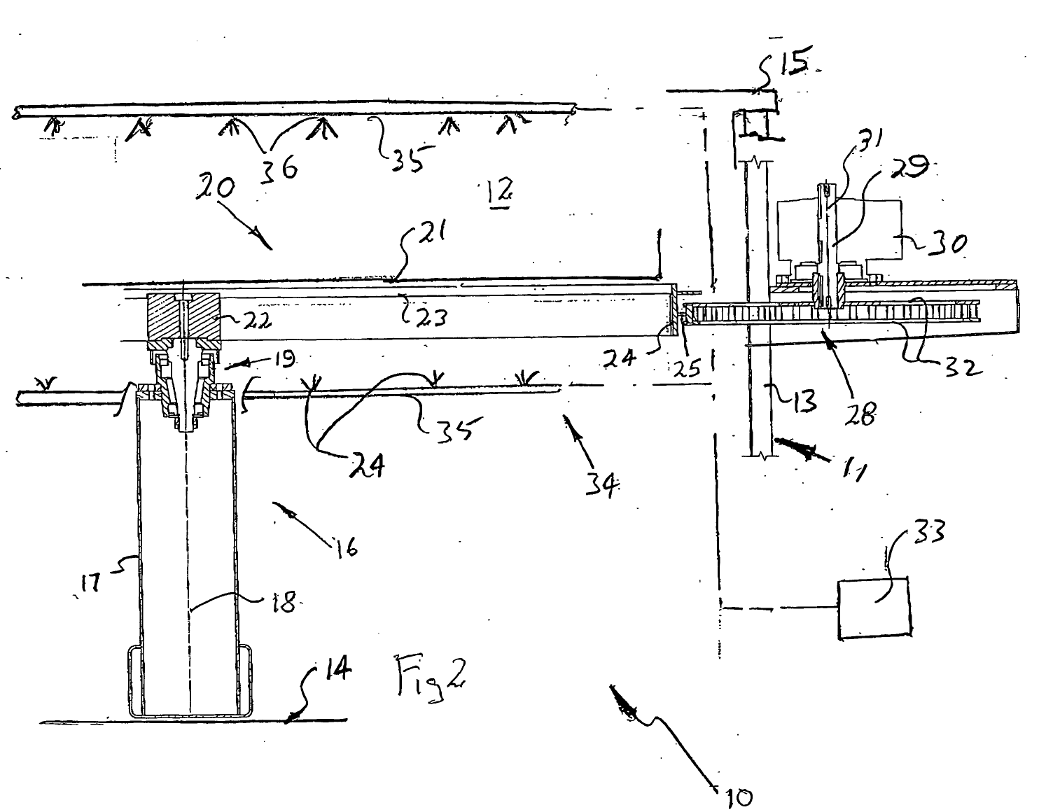

As is best seen in FIG. 2, the pinion assembly 28 includes an upper and lower plate 32 between which and to which there is attached the pins 29. The pins 29 are equally angularly spaced about the axis 31. The axis 31 is generally parallel to the axis 18.

The pins 29 are each generally circular in transverse cross section so as to be engagable between adjacent teeth 25.

The washing machine 10 also includes a motor and pump assembly 33 that delivers a cleaning liquid (such as water) to a spray assembly 34 located within the cabinet 11. The spray assembly 34 includes pipes 35, each having a plurality of nozzles 36 that direct spray jets at the tray 21 and therefore the items located thereon.

1. A washing machine including:
a cabinet to receive items to be washed;
a turntable within the cabinet mounted for rotation about a generally upright turntable axis, the turntable providing a support to receive the items;
a spray assembly including a plurality of nozzles within the cabinet;
a pump to deliver a cleaning liquid under pressure to the spray assembly so that liquid jets, to be directed at the items, issue from the nozzles; and
a drive assembly to rotate the turntable about said axis, said drive assembly including,
a plurality of sprocket teeth, the teeth being part of the turntable and having a major direction of extension generally radially relative to said turntable axis, said teeth being equally angularly spaced about said turntable axis so as to provide a sprocket, and a pinion meshingly engaged with the sprocket and mounted for rotation about a pinion axis, said pinion including a plurality of pinion teeth, the pinion teeth being meshingly engaged with the sprocket teeth having a major direction of extension generally parallel to the turntable axis, and
a motor operatively associated with the pinion to cause rotation thereof about the pinion axis to thereby cause rotation of the turntable about the turntable axis.

2. The machine of claim 1, wherein the turntable is formed of segments that are joined together to form the turntable.

3. The machine of claim 2, wherein each segment extends for approximately 25° about the turntable axis.

4. The machine of claim 3, wherein the pinion teeth are pins that are generally circular in transverse cross section.

5. The machine of claim 2, wherein said turntable includes a central hub, a sprocket base radially spaced from the hub but surrounding the hub and to which said teeth are attached, and a plurality of spokes joining the hub and base so that the base is supported by the hub.

6. The machine of claim 5, wherein said base is a ring extending about the turntable axis, and from which the sprocket teeth radially extend.

7. The machine of claim 4, wherein adjacent sprocket teeth are joined by an arcuate portion.

8. The machine of claim 1, wherein said pinion axis is generally parallel to said turntable axis but spaced laterally therefrom.
